(19) United States
(12) Patent Application Publication
(10) Pub. No.: US 2013/0107377 A1
(43) Pub. Date: May 2, 2013

(54) LENS MODULE

(71) Applicant: Po-Sheng Lai, Yilan County (TW)

(72) Inventor: Po-Sheng Lai, Yilan County (TW)

(21) Appl. No.: 13/283,607

(22) Filed: Oct. 28, 2011

(51) Int. Cl. G02B 17/08

(52) U.S. Cl. 359/736

(57) ABSTRACT

A lens module includes an elongated lens having a first lens, first reflect face formed on a front end thereof. A second lens and a second reflect face are respectively formed on a rear end of the elongated lens. When collecting an image, the light route of the object passes through the first lens and the first reflect face into the elongated lens, and focusing a wrong-reading image. The light route of the wrong-reading image passes through the second reflect face and the second lens and forms a light route that forms a right-reading image on a sensitize unit.

### BACKGROUND OF THE INVENTION

1. Field of the Invention

The present invention relates to a lens module, and more particularly to a lens module that directly shows a right-reading image.

2. Description of Related Art

According to the improvement of digital camera, the charge coupled device (CCD) or complementary metal oxide semiconductor (CMOS) is widely used. In addition, the pixel is continually enhanced and the volume is continually reduced for a high-quality picture and easily carrying.

However, the conventional lens module needs to use reversing lens or pentaprism for forming a right-reading image. In addition, some manufacturers use two lens modules for refracting the wrong-reading image to a right-reading image that is formed on a right-reading image.

With reference to FIG. 1, the conventional lens module (501) includes two lenses (71, 72) disposed effective focus. The incident light route (51) of the object (50) passes through the first lens (101a) into the first lens (71) via a reflect plane (1a). The light route must be exposed into different medium for first focusing after passing the second lens (101b) of the first lens (71) and forming a wrong-reading image of the object (50). The light route of the wrong-reading image passes through a third lens (102a) into the second lens (72) via the second reflect lens (4a).

Finally, the light route passes the fourth lens (102b) and forms a right-reading image on a sensitize unit (201). As a result, the mold cost and manufacturing cost are raised.

The present invention has arisen to mitigate and/or obviate the disadvantages of the conventional lens module.

### SUMMARY OF THE INVENTION

The main objective of the present invention is to provide an improved lens module that directly shows a right-reading image.

To achieve the objective, the lens module in accordance with the present invention comprises an elongated lens having a first lens, first reflect face formed on a front end thereof. A second lens and a second reflect face are respectively formed on a rear end of the elongated lens. When collecting an image, the light route of the object passes through the first lens and the first reflect face into the elongated lens, and focusing a wrong-reading image. The light route of the wrong-reading image passes through the second reflect face and the second lens and forms a light route that forms a right-reading image on a sensitize unit. For showing a right-reading image on the sensitize unit, the lens module has a simplified structure relative to the conventional lens module such that the manufacturing cost has been reduced.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of a conventional lens module in accordance with the prior art;

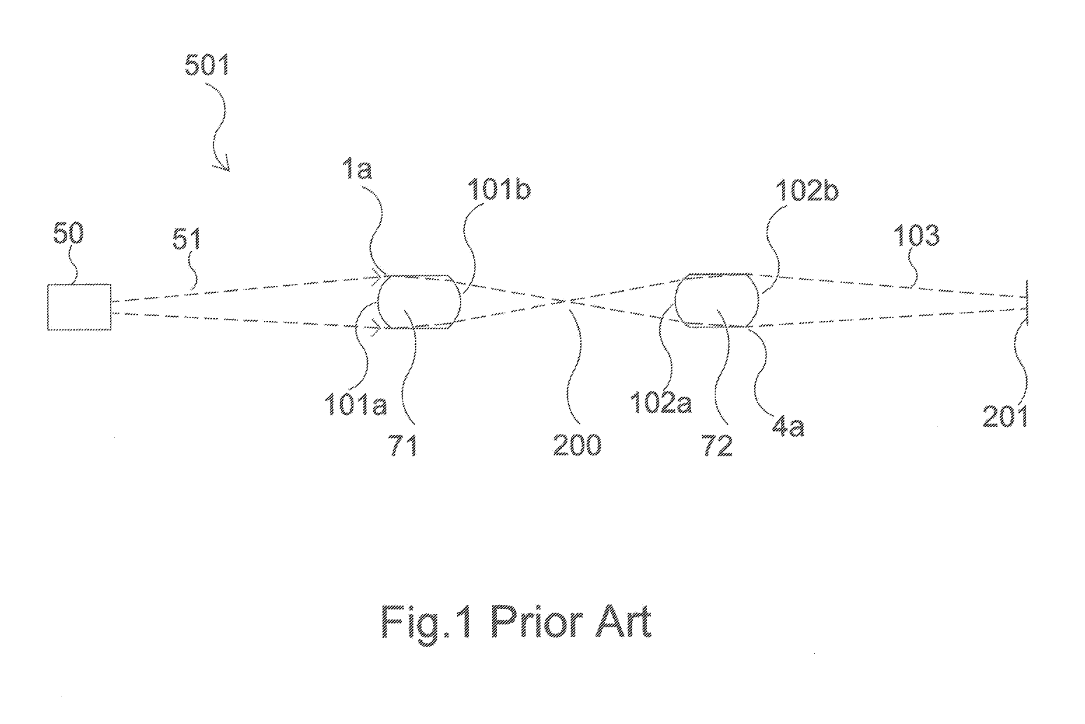

FIG. 2 is a schematic view of a lens module in accordance with the present invention; and

FIG. 3 is a schematic view of a second embodiment of the lens module in accordance with the present invention.

### DETAILED DESCRIPTION OF THE INVENTION

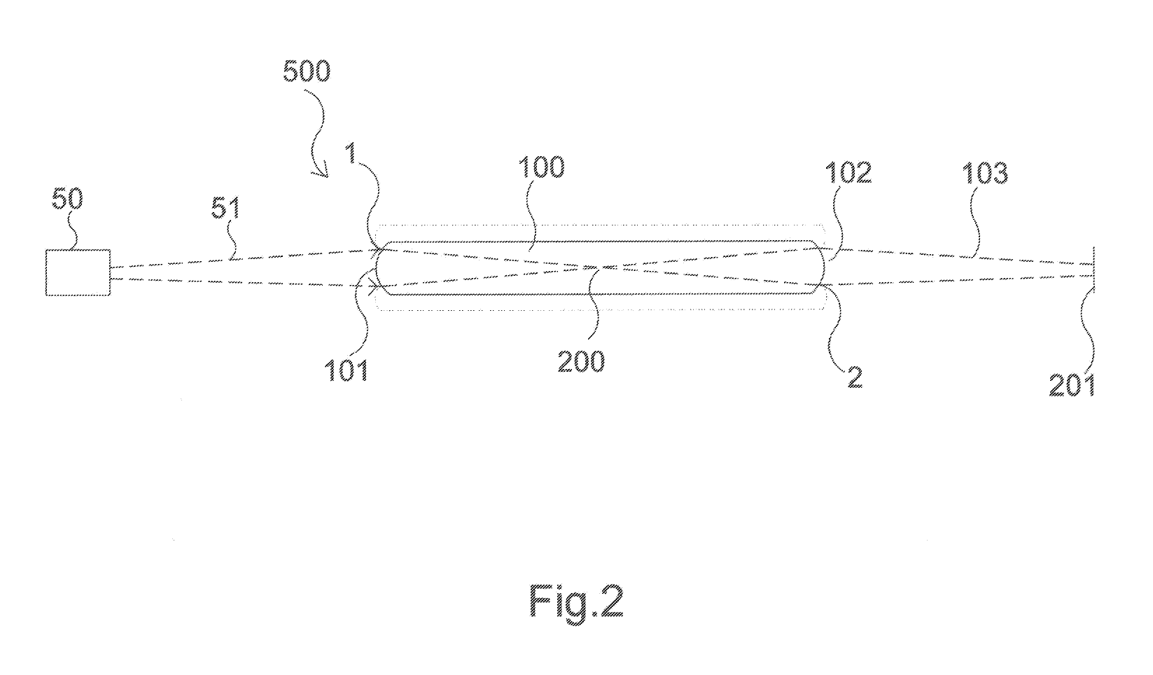

Referring to the drawings and initially to FIG. 2, a lens module (500) in accordance with the present invention can be provided to a scanner, a camera or an optical apparatus. The lens module (500) comprises an elongated lens (100) having a first lens (101), first reflect face (1) formed on a front end thereof. A second lens (102) and a second reflect face (2) are respectively formed on a rear end of the elongated lens (100). When collecting an image, the light route of the object (50) passes through the first lens (101) and the first reflect face (1) into the elongated lens (100), and focusing a wrong-reading image (200). The light route of the wrong-reading image passes through the second reflect face (2) and the second lens (102) and forms a light route (103) that forms a right-reading image on a sensitize unit (201). For showing a right-reading image on the sensitize unit (201), the lens module (500) has a simplified structure relative to the conventional lens module such that the manufacturing cost has been reduced. In addition, the first lens (101) and the second lens (102) can be a convex lens or a concave lens for different embodiments.

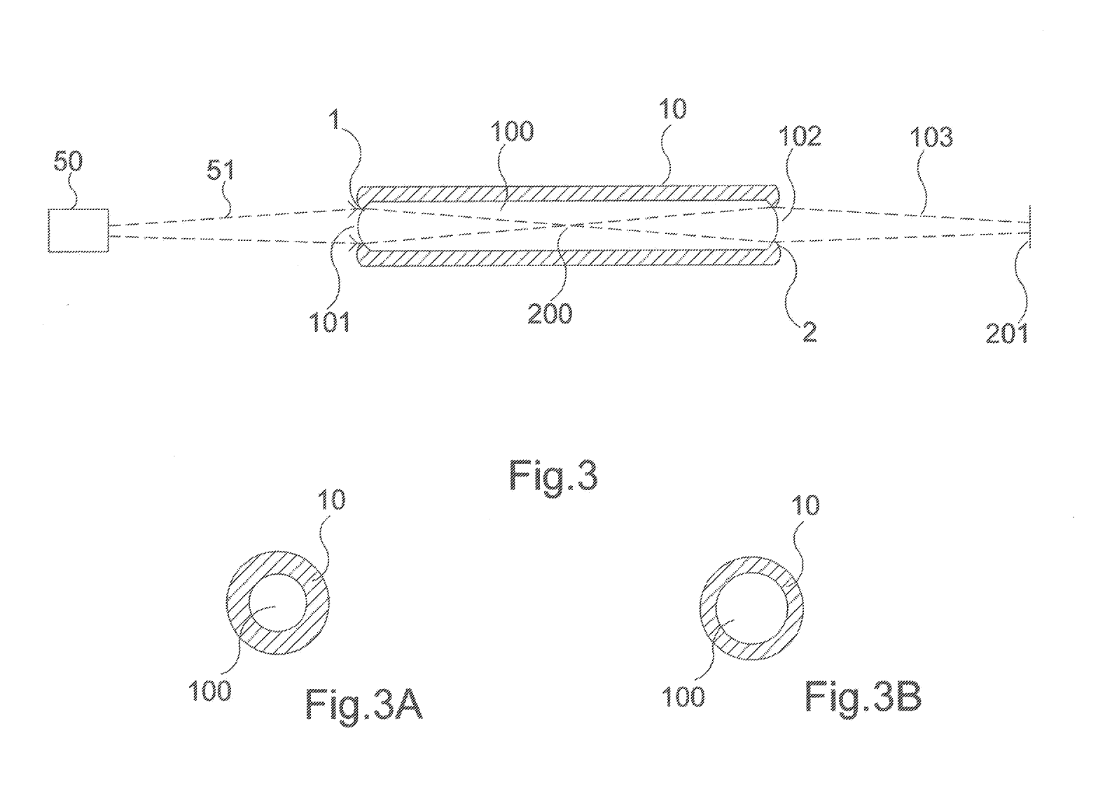

With reference to FIG. 3, FIG. 3A and FIG. 3B, the lens module in accordance with the present invention further comprises a diaphragm (10) sleeved on the elongated lens (100). As shown in FIGS. 3A-3B, the diameters of the two opposite openings of the diaphragm (10) are different from each other. Consequently, the manufacturer can easily mount the elongated lens (100) into the diaphragm (10) in a correct direction.

Although the invention has been explained in relation to its preferred embodiment, it is to be understood that many other possible modifications and variations can be made without departing from the spirit and scope of the invention as hereinafter claimed.

What is claimed is:

1. A lens module comprising:
an elongated lens having a first lens, first reflect face formed on a front end thereof, a second lens and a second reflect face respectively formed on a rear end of the elongated lens, when collecting an image, the light route of an object passing through the first lens and the first reflect face into the elongated lens, and focusing a wrong-reading image, the light route of the wrong-reading image passing through the second reflect face and the second lens and forming a light route that forms a right-reading image on a sensitize unit.

2. The lens module as claimed in claim 1 further comprising diaphragm sleeved on the elongated lens.

3. The lens module as claimed in claim 2, wherein the diameters of the two opposite openings of the diaphragm are different from each other for manufacturer to easily mount the elongated lens into the diaphragm in a correct direction.

4. The lens module as claimed in claim 1, wherein the first lens is a convex lend.

5. The lens module as claimed in claim 1, wherein the second lens is a convex lend.

6. The lens module as claimed in claim 1, wherein the first lens is a concave lend.

7. The lens module as claimed in claim 1, wherein the second lens is a concave lend.
